(19) United States
(12) Patent Application Publication
(10) Pub. No.: US 2020/0257568 A1
(43) Pub. Date: Aug. 13, 2020

(54) NODE CONTROL DEVICE, COMPUTATION PROCESSING SYSTEM, NODE CONTROL METHOD, AND RECORDING MEDIUM

(71) Applicant: NEC Corporation, Minato-ku, Tokyo (JP)

(72) Inventor: Yoshikazu WATANABE, Tokyo (JP)

(73) Assignee: NEC Corporation, Minato-ku, Tokyo (JP)

(21) Appl. No.: 16/756,007

(22) PCT Filed: Oct. 19, 2018
(86) PCT No.: PCT/JP2018/038938

§ 371 Date: Apr. 14, 2020

(30) Foreign Application Priority Data
Oct. 20, 2017 (JP) 2017-203660

(51) Int. Cl. G06F 9/50; H04W 16/04; H04L 29/08; H04W 28/10; H04W 72/04

(52) U.S. Cl. CPC G06F 9/5072; G06F 9/505; H04W 72/042; H04L 67/10; H04W 28/10; H04W 16/04

(57) ABSTRACT

The purpose of the present invention is to more efficiently use computation processing resources in a plurality of regions by appropriately scheduling the use of the computation processing resources. A traffic forecasting unit (140D) forecasts traffic passing through a communication node. A scheduling unit (110D) determines the usage schedule of computation processing resources possessed by the communication node in order to process the forecast traffic. When the communication node possesses a vacant computation processing resource that is not scheduled to be used, a resource selling unit (120D) supplies the vacant computation processing resource.

### TECHNICAL FIELD

The present invention relates to a node control device, a computation processing system, a node control method, and a recording medium, and more specifically relates to a node control device that controls a plurality of communication nodes.

### BACKGROUND ART

In a mobile communication system, a centralized-radio access network (C-RAN) architecture in which a plurality of base stations are controlled by one communication node is being used. When the C-RAN architecture is used, usage efficiency of a base station facility can be improved. PTL 1 discloses one example of a related mobile communication system using the C-RAN architecture.

By using FIG. 19, one example of a configuration of a related mobile communication system 9 using the C-RAN architecture is described.

In the mobile communication system 9 illustrated in FIG. 19, base band units (BBUs) 910 and 920 (hereinafter, referred to as a “BBU 910 (920)”) each connect to the Internet 940 via a core network 930. The BBU 910 (920) is relevant to a communication node. The core network 930 may be, for example, an evolved packet core (EPC) of a Long-Term Evolution (LTE) network. For example, a BBU-1 (910) and a remote radio head (RRH)-1A (915), and a BBU-2 (920) and an RRH-2A (925) each form one base station connected to the core network 930.

The BBU 910 (920) receives, for example, an Internet Protocol (IP) packet from the core network 930 and transmits a baseband signal generated from the received IP packet, control information generated by the BBU 910 (920) itself, and the like, to RRHs 915 and 925 (hereinafter, referred to as an “RRH 915 (925)”).

The RRH 915 (925) converts the baseband signal received from the BBU 910 (920) to a radio frequency (RF) signal and transmits the converted RF signal to a user device (not illustrated). The RRH 915 (925) receives an RF signal from a user device and converts the received RF signal to a baseband signal. The RRH 915 (925) then transmits the converted baseband signal to the BBU 910 (920). The BBU 910 (920) processes the received baseband signal and extracts control information and an IP packet, and thereby executes processing in accordance with the control information, transmits the IP packet to the core network 930, and the like.

In FIG. 19, RRHs-1A to 1C included in the RRH 915 wirelessly communicate with user devices (not illustrated) located in areas (cells) different from one another. For example, the RRH-1A is assigned to an office area, the RRH-1B is assigned to a residential area, and the RRH-1C is assigned to an intermediate area between these areas.

The BBU 910 (920) can simultaneously establish, in a wireless or wired manner, a connection to a part or all of the RRHs 915 (925). The BBU 910 (920) can dynamically distribute, when the BBU 910 (920) executes processing, a processing capability (e.g. a computation processing resource) to one or a plurality of connected RRHs 915 (925).

In an office area, generally, traffic increases during a daytime and decreases during a night-time. In contrast, in a residential area, during a weekday daytime, traffic does not increase so much.

By using an example in which, in each of areas including an office area, a residential area, and an intermediate area, one base station is deployed, an advantageous effect of the C-RAN architecture is described. In a mobile communication system not using the C-RAN architecture, it is necessary for each base station to have a processing capability capable of coping with a maximum communication volume of traffic that may be generated in an assigned area. While, for example, during a weekday daytime, a base station deployed in an office area processes enormous traffic, there is room for a processing capability (hereinafter, also referred to as a “computation processing resource”) of a base station deployed in a residential area. Therefore, when viewed from an entire mobile communication system, a computation processing resource of a base station deployed in a residential area is not efficiently used.

In contrast, in the mobile communication system 9 using the C-RAN, when traffic in an office area increases, the BBU 910 redistributes a part of a computation processing resource distributed for processing traffic of the RRHs-1B and 1C in order to process traffic of the RRH-1A deployed in an office area. The RRH-1A does not always need to be provided with a processing capability capable of coping with a maximum communication volume of traffic. The BBU 910 distributes a surplus computation processing resource generated due to a decrease in traffic of the RRHs-1B and 1C to processing of traffic of the RRH-1A, and thereby can improve a traffic processing capability of the RRH-1A.

PTL 2 describes one example of a configuration in which, in a mobile communication system using the C-RAN architecture, a change in traffic is forecast and a vacant computation processing resource of a base station is dynamically distributed to another base station.

### CITATION LIST

### Patent Literature

[PTL 1] Japanese Unexamined Patent Application Publication No. 2017-120977

[PTL 2] International Publication No. WO 2015/045444

[PTL 3] Japanese Unexamined Patent Application Publication No. 2015-144343

### SUMMARY OF INVENTION

### Technical Problem

In a related mobile communication system described in PTL 2, after a vacant computation processing resource of a base station is distributed to another base station, based on a forecast result of a change in traffic, a vacant computation processing resource may remain. In this case, in the related mobile communication system, a remaining vacant computation processing resource is useless. PTL 2 does not disclose this problem.

An object of the present invention is to more efficiently use a computation processing resource by appropriately scheduling use of a computation processing resource in a plurality of areas.

### Solution to Problem

A node control device according to one aspect of the present invention includes: a traffic forecasting means that forecasts traffic passing through a communication node; a scheduling means that determines a usage schedule of a computation processing resource on the communication node in order to process the forecast traffic; and a resource supply means that supplies a remaining vacant computation processing resource acquired by excluding a computation processing resource determined to be used from a total computation processing resource possessed by the communication node.

A computation processing system according to one aspect of the present invention includes: a node control device; the communication node controlled by the node control device; and one or more wireless communication devices that connect to the communication node and wirelessly communicate with a user device.

A node control method according to one aspect of the present invention includes: forecasting traffic passing through a communication node; determining a usage schedule of a computation processing resource on the communication node in order to process the forecast traffic; and supplying a remaining vacant computation processing resource acquired by excluding a computation processing resource determined to be used from a total computation processing resource possessed by the communication node.

A recording medium according to one aspect of the present invention stores a program that causes a computer to execute: forecasting traffic passing through a communication node; determining a usage schedule of a computation processing resource on the communication node in order to process the forecast traffic; and supplying a remaining vacant computation processing resource acquired by excluding a computation processing resource determined to be used from a total computation processing resource possessed by the communication node.

### Advantageous Effects of Invention

According to one aspect of the present invention, a computation processing resource of a communication node can be more efficiently used.

### BRIEF DESCRIPTION OF DRAWINGS

FIG. 1 is a diagram illustrating a configuration example of a computation processing system according to a first example embodiment.

FIG. 2 is a diagram illustrating a configuration example of a node control device according to the first example embodiment.

FIG. 3 is a diagram illustrating a configuration example of a communication node according to the first example embodiment.

FIG. 4 is a diagram illustrating a configuration example of a user device according to the first example embodiment.

FIG. 5 is a diagram illustrating one example of storage of a traffic history and a forecast of traffic based on the node control device according to the first example embodiment.

FIG. 6 is a diagram illustrating one example of a resource distribution table used by the node control device according to the first example embodiment.

FIG. 7 is a diagram illustrating one example of a computation processing resource (per unit traffic) necessary for a baseband processing unit used by the node control device according to the first example embodiment.

FIG. 8 is a diagram illustrating a first operation example of the computation processing system according to the first example embodiment.

FIG. 9 is a diagram illustrating a second operation example of the computation processing system according to the first example embodiment.

FIG. 10 is a diagram illustrating a third operation example of the computation processing system according to the first example embodiment.

FIG. 11 is a diagram illustrating a fourth operation example of the computation processing system according to the first example embodiment.

FIG. 12 is a diagram illustrating a fifth operation example of the computation processing system according to the first example embodiment.

FIG. 13 is a diagram illustrating a configuration example of a computation processing system according to a second example embodiment.

FIG. 14 is a diagram illustrating a configuration example of a user device of the second example embodiment.

FIG. 15 is a diagram illustrating a configuration example of a node control device according to a third example embodiment.

FIG. 16 is a diagram illustrating an operation example of a computation processing system according to the third example embodiment.

FIG. 17 is a diagram illustrating a configuration example of a node control device according to a fourth example embodiment.

FIG. 18 is a diagram illustrating a configuration example of a node control device according to a fifth example embodiment.

FIG. 19 is a diagram illustrating a configuration example of a related mobile communication system using a C-RAN architecture.

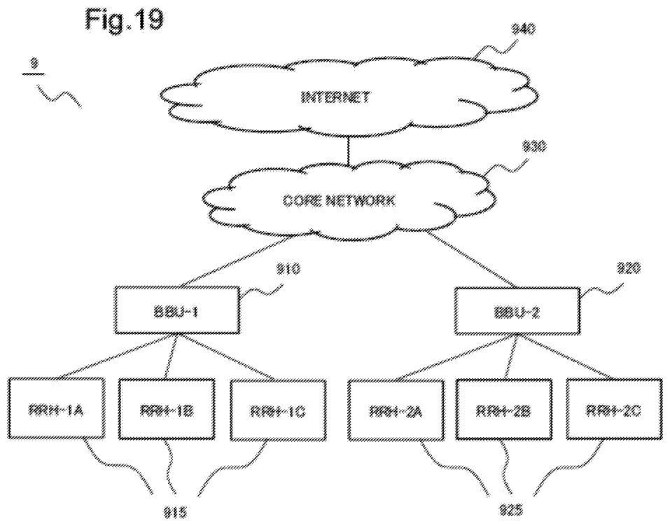

### EXAMPLE EMBODIMENT

### First Example Embodiment

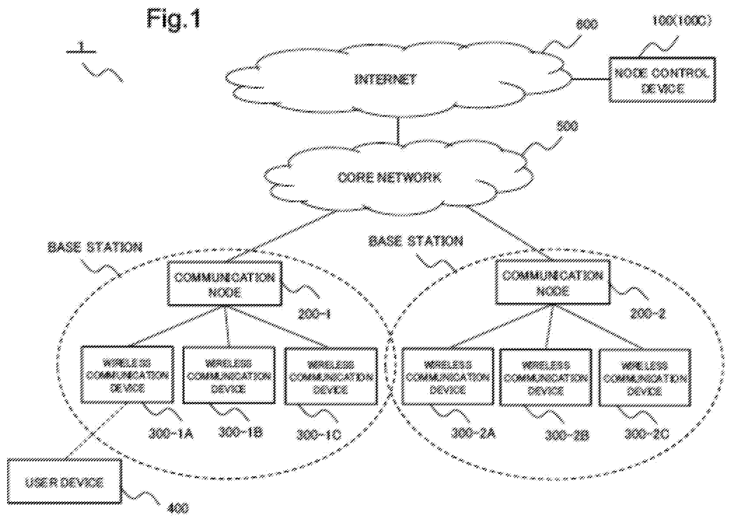

By using FIGS. 1 to 12, a first example embodiment of the present invention is described.

FIG. 1 is a configuration diagram illustrating one example of a configuration of a computation processing system 1 according to the first example embodiment. The computation processing system 1 exemplarily illustrated in FIG. 1 includes a node control device 100, communication nodes 200-1 and 2, wireless communication devices 300-1A to 300-2C, a user device 400, and a core network 500. The communication nodes 200-1 and 2 connect to the Internet 600 via the core network 500. A part of a reference sign added with a branch number is omitted. For example, 200-1 and 2 represent 200-1 and 200-2. 100C represents a node control device according to a third example embodiment to be described later.

The number of components of the computation processing system 1 illustrated in FIG. 1 and a connection relation between components are one example. Branch numbers of these members (e.g. 1 and 2 of the communication nodes 200-1 and 2) may be omitted in the following description only when there is no possibility of confusion.

The communication node 200, the wireless communication device 300, and the core network 500 configure a mobile communication system, for example, possessed and operated by a mobile communication carrier. A mobile communication system may be based on, for example, a standard of the 3rd Generation (3G), LTE, LTE-Advanced, or the 5th Generation (5G).

The node control device 100 accesses the communication nodes 200-1 and 200-2 via the Internet 600 and the core network 500 and controls an operation of the communication nodes 200-1 and 200-2. The node control device 100 sells a vacant computation processing resource of the communication node 200 to a user. Selling indicates that a reservation for using a vacant computation processing resource of the communication node 200 by a user is accepted in exchange for a price or without charge. Selling herein is one example of supply of a vacant computation processing resource. A computation processing resource is an element of a computer consumed or used for executing computation processing, and according to the present example embodiment, operation performance of a computation processing unit 210 included in the communication node 200, a capacity of an internet bus 211, a capacity of a memory unit 212, a capacity of a secondary storage unit 2132, and a capacity of a communication unit 214 correspond to a computation processing resource. In the following, a computation processing resource may be referred to as a processing capability.

The communication node 200 operates as a BBU in a C-RAN architecture. The communication node 200 executes baseband processing by using a computation processing resource of a local device. Baseband processing includes processing of generating a baseband signal from an IP packet received by the communication node 200 from the core network 500 and processing of converting, to an IP packet, a baseband signal received by the communication node 200 from the wireless communication device 300. The communication node 200 executes, by using a computation processing resource of a local device, information processing specified from the user device 400.

The wireless communication device 300 is equivalent to, for example, a radio unit (RRH) in a C-RAN architecture. The wireless communication device 300 converts a baseband signal received from the communication node 200 to an RF signal and transmits the RF signal to the user device 400. The wireless communication device 300 converts an RF signal received from the user device 400 to a baseband signal and transmits the baseband signal to the communication node 200. The communication node 200 and the wireless communication device 300, for example, may be connected by a wired line such as an optical fiber and the like or may be connected by any wireless line.

The user device 400 is possessed or operated, for example, by a user having a contract for a mobile communication service provided by a mobile communication carrier. The user device 400 connects to a base station achieved by the communication node 200 and the wireless communication device 300 and communicates with the base station. The user device 400 executes information processing by using a computation processing resource of a local device and/or a computation processing resource of the communication node 200.

The core network 500 is, for example, a mobile communication network included in the computation processing system 1. The core network 500 conforms to any mobile communication standard. The core network 500 is, for example, an EPC conforming to the LTE standard. In this case, the core network 500 includes a policy and charging rules function (PCRF), a mobility management entity (MME), a serving gateway (S-GW), and a packet data network gateway (P-GW).

The Internet 600 is a network where devices conforming to IP are mutually connected.

(Node Control Device 100)

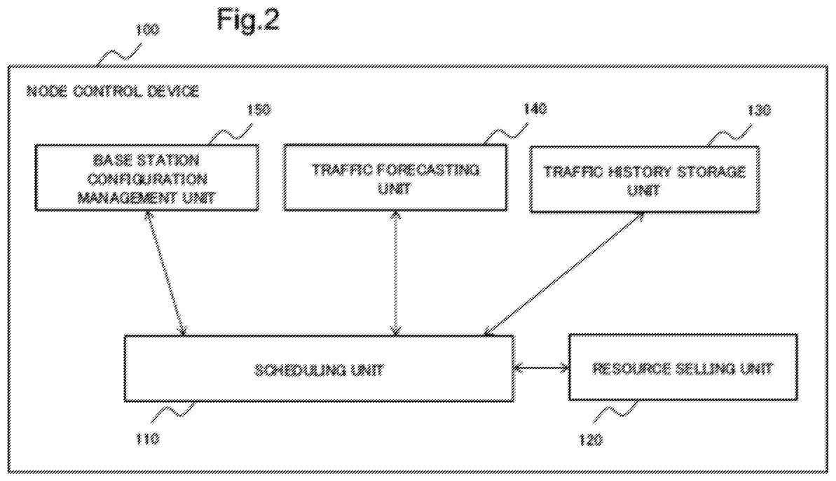

By using FIG. 2, a configuration example of the node control device 100 according to the present example embodiment is described.

The node control device 100 exemplarily illustrated in FIG. 2 includes a scheduling unit 110, a resource selling unit 120, a traffic history storage unit 130, a traffic forecasting unit 140, and a base station configuration management unit 150.

The scheduling unit 110 determines a usage schedule of a computation processing resource of the communication node 200. Scheduling is to determine an amount, a type, and a usage time of a computation processing resource used for baseband processing in the communication node 200 and information processing specified from the user device 400. Details of scheduling are described later.

The resource selling unit 120 sells a vacant computation processing resource in a computation processing resource of the communication node 200 to the user device 400. A vacant computation processing resource is a remaining computation processing resource that is not scheduled to be used yet except a computation processing resource scheduled to be used by the baseband processing unit 230 of the communication node 200 and an already-sold computation processing resource.

The resource selling unit 120 computes a selling price of a vacant computation processing resource and stores a list of the selling price. The resource selling unit 120 presents a vacant computation processing resource and a list of a selling price of the resource to the user device 400, for example, via a web interface and the Internet 600.

The resource selling unit 120 requests, when receiving a purchase request of a vacant computation processing resource from the user device 400, the scheduling unit 110 to ensure a purchased vacant computation processing resource. The resource selling unit 120 receives, from the user device 400, a payment for a purchased vacant computation processing resource, for example, through a charging system included in a mobile communication system included in the computation processing system 1. Alternatively, the resource selling unit 120 may receive a payment from the user device 400 through a charging system (not illustrated, e.g. a system provided by a credit card company) independent of the mobile communication system.

The traffic history storage unit 130 acquires information relating to a communication load and traffic with respect to each baseband processing unit 230 of the communication node 200 and stores the acquired information as history information. The traffic history storage unit 130 may take statistics of communication loads on baseband processing units 230 of the communication node 200 and traffic passing through the baseband processing units 230 of the communication node 200, for example, for each given time (e.g. one minute or one hour) and store the statistics.

The traffic forecasting unit 140 forecasts a communication load and traffic at a certain future time, by using at least one of information stored in the traffic history storage unit 130, a current time, a communication load, and information of traffic and the like. Details of a method of forecasting a communication load and traffic are described later.

The base station configuration management unit 150 determines a configuration of a base station (hereinafter, referred to as a “base station configuration”). According to the present example embodiment, a base station refers to a combination of a communication node 200 and a wireless communication device 300 connected to the communication node 200. A base station configuration refers to a combination of a communication node 200 and a valid (i.e., operating) wireless communication device 300.

The base station configuration management unit 150 determines what wireless communication device 300 is caused to be valid/invalid and determines a parameter of a base station. One example of a parameter of a base station includes a used frequency, a frequency band, a modulation/demodulation method, a multiplexing method, a frame format, a retransmission method, and a transmission power.

The base station configuration management unit 150 may determine a base station configuration, based on a related technique such as self-organizing networks (SON) and the like. The base station configuration management unit 150 may determine a base station configuration, for example, based on the following input.
Traffic forecast in the traffic forecasting unit 140
Installation places and capabilities of wireless communication devices 300
A correspondence relation between wireless communication devices 300 and each communication node 200
A processing capability (a computation processing resource) of each communication node 200

A part of the input may be previously provided to the base station configuration management unit 150 or may be dynamically acquired.

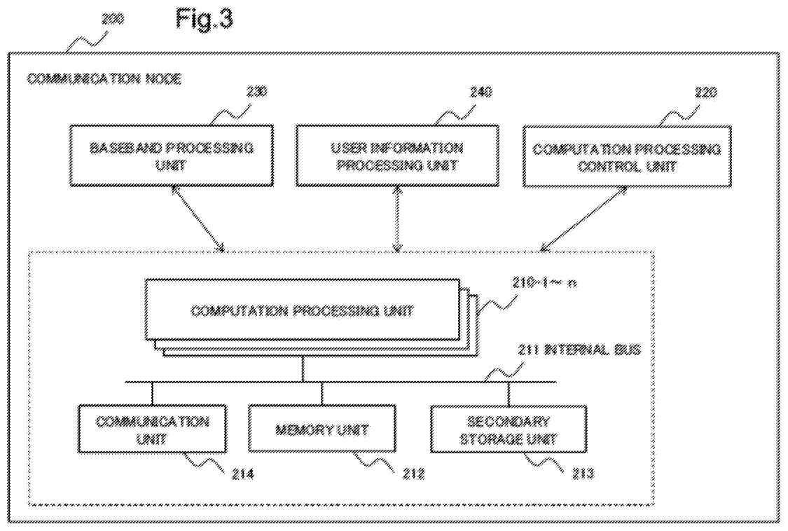

Next, a configuration example of the communication node 200 according to the present example embodiment is described by using FIG. 3.

The communication node 200 exemplarily illustrated in FIG. 3 includes the computation processing units 210-1 to n, the internal bus 211, the memory unit 212, a secondary storage unit 213, the communication unit 214, a computation processing control unit 220, a baseband processing unit 230, and a user information processing unit 240.

The computation processing units 210-1 to n each are, for example, hardware (HW) that executes computation processing. The computation processing unit 210 may be, for example, any one of a central processing unit (CPU), a field-programmable gate array (FPGA), a graphics processing unit (GPU), a digital signal processor (DSP), and an application specific integrated circuit (ASIC) or a combination thereof.

The computation processing units 210-1 to n may be devices different in type from each other or may include configurations different from each other. The computation processing units 210-1 to n may include a memory and a secondary storage.

The internal bus 211 causes the computation processing units 210-1 to n, the memory unit 212, the secondary storage unit 213, and the communication unit 214 to be mutually connected. A plurality of or a plurality of types of internal buses 211 may be provided, or the internal bus 21 may be provided as a point-to-point type.

The memory unit 212 is a main memory. The memory unit 212 stores, for example, a program executed by the computation processing unit 210 and data to be processed.

The secondary storage unit 213 is, for example, a hard disk drive (HDD) or a solid state drive (SSD). The secondary storage unit 213 stores, for example, a program executed by the computation processing unit 210 and/or data to be processed.

The communication unit 214 is a communication interface (IF) in which the communication node 200 connects to the wireless communication device 300 and the core network 500 and communicates therewith. When a plurality of communication destinations (i.e., wireless communication devices 300-1 to n) of the communication node 200 exist, a plurality of communication units 214 may exist. Alternatively, the communication unit 214 may include a switching mechanism in an inside, and the computation processing unit 210 may switch with what connection destination communication is performed.

The computation processing control unit 220 controls the computation processing unit 210, the internal bus 211, the memory unit 212, the secondary storage unit 213, and the communication unit 214. The computation processing control unit 220 controls these members and thereby controls use of a computation processing resource by the baseband processing unit 230 and the user information processing unit 240.

The computation processing control unit 220 may include, for example, a function of an operating system (OS) and a hypervisor. The computation processing control unit 220 may include an interface for measuring a usage rate of a computation processing resource on the baseband processing unit 230 and the user information processing unit 240 and reporting the measured usage rate.

The baseband processing unit 230 executes a function, specifically baseband processing, other than a function assigned to the wireless communication device 300 among functions of a base station.

A function of the baseband processing unit 230 is achieved by using a computation processing resource (specifically, a part or all of the computation processing unit 210, the internal bus 211, the memory unit 212, the secondary storage unit 213, and the communication unit 214).

A function of the baseband processing unit 230 may be achieved by using a plurality of computation processing units 210. In this case, a plurality of computation processing units 210 may include pieces of HW different from each other. When the computation processing unit 210 is a CPU, a GPU, or a DSP, a partial function (a function executed by the computation processing unit 210) of the baseband processing unit 230 may be achieved as, for example, software (SW). In this case, a program is read from the secondary storage unit 213 to the memory unit 212, is executed by the computation processing unit 210, and thereby functions as the baseband processing unit 230. The baseband processing unit 230 includes an interface for measuring a communication load and/or traffic and reporting the measured traffic to the node control device 100.

The user information processing unit 240 executes information processing specified by the user device 400. In the following, the information processing is referred to as user information processing. User information processing may include, for example, video analysis processing, big data processing, Internet of things (IoT) processing, machine learning processing, and artificial intelligence (AI) processing.

A function of the user information processing unit 240 is achieved by using a computation processing resource (specifically, a part or all of operation performance of the computation processing unit 210, a capacity of the internal bus 211, a capacity of the memory unit 212, a capacity of the secondary storage unit 213, and a capacity of the communication unit 214).

A function of the user information processing unit 240 may be achieved by using a plurality of computation processing units 210. In this case, a plurality of computation processing units 210 may include pieces of HW different from each other.

When the computation processing unit 210 is a CPU, a GPU, or a DSP, a partial function (a function executed by the computation processing unit 210) of the user information processing unit 240 may be achieved as, for example, SW. In these cases, a program is read from the secondary storage unit 213 to the memory unit 212, is executed by the computation processing unit 210, and thereby functions as the user information processing unit 240.

When the computation processing unit 210 is an FPGA, a partial function (a function executed by the computation processing unit 210) of the baseband processing unit 230 and the user information processing unit 240 may be, for example, FPGA configuration information (a bitstream).

A part or all of the baseband processing unit 230 and the user information processing unit 240 may be achieved as a virtual machine (VM).

(User Device 400)

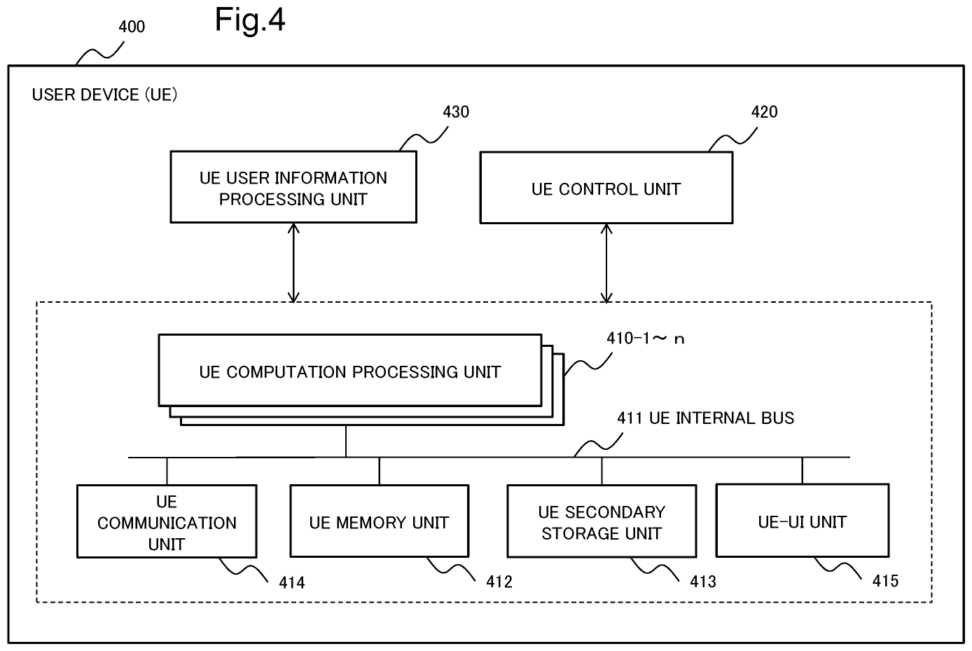

A configuration example of the user device (user equipment (UE)) 400 according to the present example embodiment is described by using FIG. 4.

The user device 400 exemplarily illustrated in FIG. 4 includes UE computation processing units 410-1 to n, a UE internal bus 411, a UE memory unit 412, a UE secondary storage unit 413, a UE communication unit 414, a UE-user interface (UI) unit 415, a UE control unit 420, and a UE user information processing unit 430.

The UE computation processing units 410-1 to n each are, for example, HW that executes computation processing. The UE computation processing unit 410 may be, for example, any one of a CPU, an FPGA, a GPU, a DSP, and an ASIC or a combination thereof. A plurality of UE computation processing units 410 may be devices different in type from each other. The UE computation processing units 410-1 to n may include a memory and a secondary storage in the inside.

The UE internal bus 411 causes the UE computation processing units 410-1 to n, the UE memory unit 412, the UE secondary storage unit 413, the UE communication unit 414, and the UE-UI unit 415 to be mutually connected. A plurality of UE internal buses 411 may be provided or a plurality of types of UE internal buses 411 may be provided. Alternatively, the UE internal bus 411 may be provided as a point-to-point type.

The UE memory unit 412 is a main memory of the user device 400. The UE memory unit 412 stores, for example, a program executed by the UE computation processing unit 410 and data to be processed.

The UE secondary storage unit 413 may be, for example, an HDD or an SSD. The UE secondary storage unit 413 stores, for example, a program executed by the UE computation processing unit 410 or data to be processed.

The UE communication unit 414 conforms to a mobile communication standard used by a mobile communication system included in the computation processing system 1. The UE communication unit 414 connects to and communicates with the wireless communication device 300.

The UE-UI unit 415 provides a user interface (UI) and takes a role in executing input/output between a user and the user device 400. The UE-UI unit 415 includes, for example, a display, a mouse, and a keyboard.

The UE control unit 420 controls the UE computation processing unit 410, the UE internal bus 411, the UE memory unit 412, the UE secondary storage unit 413, the UE communication unit 414, and the UE-UI unit 415. The UE control unit 420 controls these members and thereby controls an operation of the UE user information processing unit 430. The UE control unit 420 may include a function of, for example, an OS and/or a hypervisor. The UE control unit 420 receives an instruction from a user, for example, through the UE-UI unit 415. The UE control unit 420 controls, based on the received instruction, an operation of the UE user information processing unit 430.

The UE user information processing unit 430 may receive data input from, for example, a sensor, a camera, a communication IF, an input/output device (these being not illustrated) connected to the UE internal bus 411 or acquire data stored in the UE secondary storage unit 413 and execute the above-described user information processing for the received or acquired data.

User information processing executed by the UE user information processing unit 430 may include, for example, video analysis processing, big data processing, Internet of things (IoT) processing, machine learning processing, and artificial intelligence (AI) processing.

A function of the UE user information processing unit 430 is achieved by using a part or all of the UE computation processing unit 410, the UE internal bus 411, the UE memory unit 412, and the UE secondary storage unit 413.

A function of the UE user information processing unit 430 may be achieved by using a plurality of UE computation processing units 410. In this case, a plurality of UE computation processing units 410 may include pieces of HW different from each other.

When the UE computation processing unit 410 is a CPU, a GPU, or a DSP, a partial function (a function executed by the UE computation processing unit 410) of the UE user information processing unit 430 may be achieved as, for example, SW. In this case, a program is read from the UE secondary storage unit 413 to the UE memory unit 412 and executed by the UE computation processing unit 410.

When the UE computation processing unit 410 is an FPGA, a partial function (a function executed by the UE computation processing unit 410) of the UE user information processing unit 430 may be, for example, processing of bitstream information indicating a configuration of an FPGA. In this case, a program may be read from the UE secondary storage unit 413 to the UE computation processing unit 410 and executed.

A part or all of the UE user information processing unit 430 may be achieved as a virtual machine.

(Traffic Forecast Method)

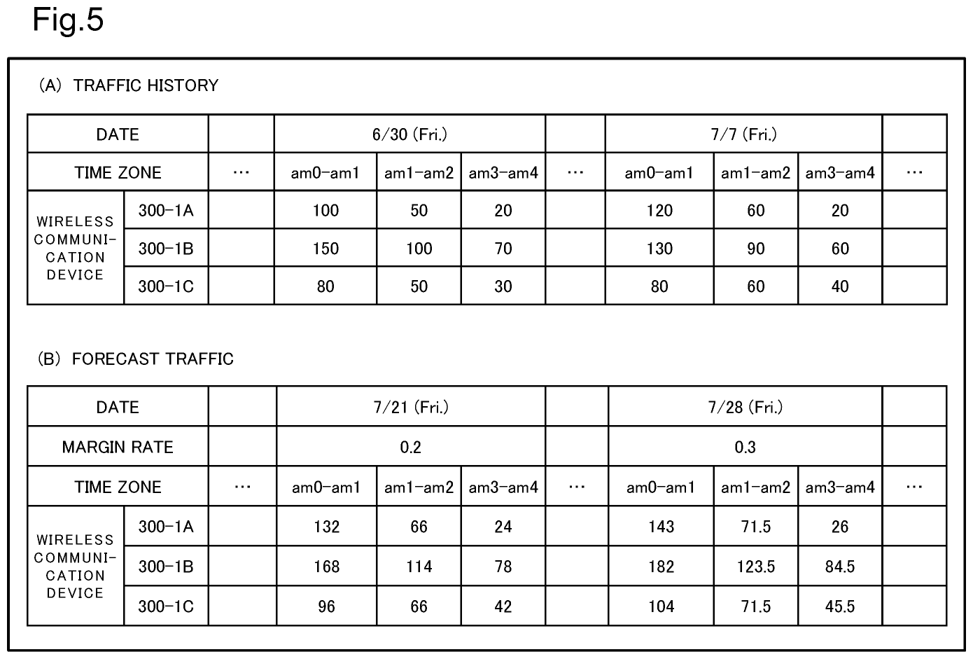

By using (A) and (B) of FIG. 5, one example of a method in which the node control device 100 forecasts traffic passing through baseband processing units 230 of each base station is described.

(A) of FIG. 5 is one example of traffic history data stored in the traffic history storage unit 130, and (B) of FIG. 5 is one example of traffic forecast by the traffic forecasting unit 140. A traffic forecast result illustrated in (B) of FIG. 5 is stored on a memory and read from the memory by a CPU of the node control device 100.

The traffic history storage unit 130 stores average traffic (unit: Mbps), for example, in a latest one-hour period every hour. The baseband processing unit 230 of the communication node 200 computes average traffic in a latest one-hour period and stores the computation result in the traffic history storage unit 130 as traffic information.

In (A) of FIG. 5, average traffic of a base station logically achieved by a base station wireless communication device 300-1A (the base station being hereinafter referred to as the base station 300-1A) and the baseband processing unit 230 of the communication node 200-1 in a period from 0:00 am to 1:00 am on June 30 (Friday) is 100 Mbps. In (A) of FIG. 5, average traffic from 0:00 am to 1:00 am on July 7 (Friday) of the base station 300-1A is 120 Mbps.

The traffic forecasting unit 140 according to the present example embodiment may forecast average traffic (hereinafter, referred to as a “traffic forecast value” or a “traffic forecast result”) in a certain future time zone, for example, based on the following expression.

(Traffic forecast value)=(an average value of a traffic history for latest two weeks at a forecast execution time in a forecast target day/time zone)×(1+a margin rate in a forecast target day or time zone)

(B) of FIG. 5 illustrates a part of a traffic forecast result at 1:00 am on July 13. For example, a traffic forecast value from 0:00 am to 1:00 am on July 21 (Friday) is computed as follows. Herein, it is assumed that a margin rate is 0.2.

(100+200)/2×(1+0.2)=132

A traffic forecast value from 0:00 am to 1:00 am on July 28 (Friday) is computed as follows. Herein, it is assumed that a margin rate is 0.3.

(100+120)/2×(1+0.3)=143

A margin rate in a forecast target day of the week/time zone may be previously provided, for example, to the traffic forecasting unit 140. A margin rate in a forecast target day of the week/time zone may be set higher as a time to a forecast target day is longer.

A forecast method based on the traffic forecasting unit 140 described here is merely one example.

(Scheduling Method)

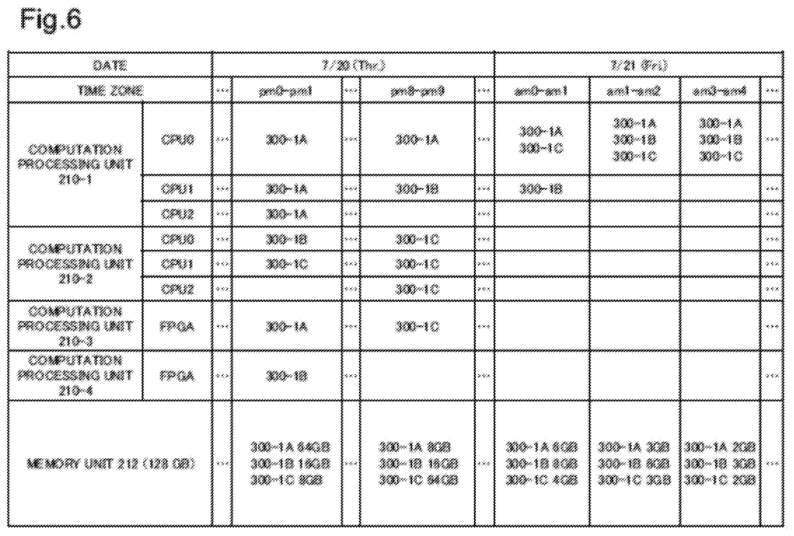

By using FIG. 6, one example of a method in which the node control device 100 determines a usage schedule of a computation processing resource is described.

FIG. 6 illustrates a resource distribution table with respect to the communication node 200-1. A resource distribution table is stored on a memory of the node control device 100 and read by a CPU from the memory.

The scheduling unit 110 determines, by referring to a resource distribution table, for what computation processing and how much a computation processing resource possessed by the communication node 200 is used for each predetermined time (one hour in FIG. 6).

In the example illustrated in FIG. 6, computation processing units 210-1 and 2 of the communication node 200-1 each include three CPUs 0 to 2. Computation processing units 210-3 and 4 each include an FPGA. A capacity of the memory unit 212 is 128 GB.

The resource distribution table illustrated in FIG. 6 indicates which one of wireless communication devices 300-1A to 300-1C uses a computation processing resource (e.g. CPUs 0 to 2, an FPGA, and a memory) included in the computation processing units 210-1 to 201-4 in time zones of each day. Reference signs 300-1A to 300-1C in FIG. 6 each represent the wireless communication devices 300-1A to 300-1C that use a computation processing resource. For example, in p.m.0 to p.m.1 on July 20, a computation capability of a CPU 0 of the computation processing unit 210-1 is used by the wireless communication device 300-1A. In other words, the CPU 0 of the computation processing unit 210-1 executes computation processing, instead of the wireless communication device 300-1A. A blank of the resource distribution table indicates that in the time zone of the blank, there is no usage schedule of a computation processing resource. For example, in p.m.8 to p.m.9 on July 20, operation performance of the computation processing unit 210-4 is equivalent to a vacant computation processing resource.

The scheduling unit 110 determines, based on input information, a usage schedule of a computation processing resource with respect to a time zone of a blank in a resource distribution table. The scheduling unit 110 determines a usage schedule of a computation processing resource, for example, by using pieces of input information I1 to I5 described below.
I1: A base station configuration (determined by the base station configuration management unit 150) in a target time zone
I2: A traffic forecast value (forecast by the traffic forecasting unit 140 and the base station configuration management unit 150) with respect to each base station
I3: A type and/or an amount of a computation processing resource possessed by the communication node 200
I4: A correspondence relation between each base station and communication nodes 200
I5: A computation processing resource (per unit traffic) necessary for the baseband processing unit 230
I3, I4, and I5 may be previously provided to the scheduling unit 110.

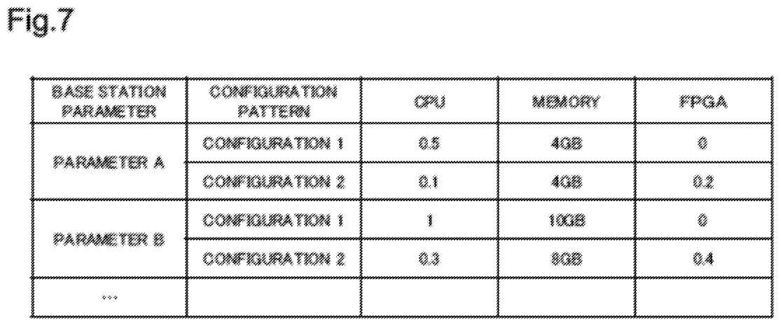

I5 described above may be in a format of a table, for example, as illustrated in FIG. 7.

FIG. 7 illustrates a computation processing resource (for each traffic of 100 Mbps) necessary for the baseband processing unit 230. When a processing load on a base station is different according to a parameter of the base station, input information may be provided for each parameter (parameters A and B in FIG. 7). When necessary computation processing resources are different according to a configuration of a base station, input information may be provided for each combination of the resources (a configuration pattern illustrated in FIG. 7).

The scheduling unit 110 schedules use of a computation processing resource for each communication node 200, for example, as follows.

First, the scheduling unit 110 identifies, based on I4, a base station corresponding to the communication node 200.

Next, the scheduling unit 110 computes, for each base station, a computation processing resource necessary for the baseband processing unit 230, by using I1, I2, and I5. At that time, the scheduling unit 110 may compute, for each configuration pattern of a base station, necessary computation processing resources and determine the computed resources as a candidate for a computation processing resource necessary for the baseband processing unit 230.

The scheduling unit 110 determines, by considering I3 and a computation processing resource for each configuration pattern, a configuration pattern of a base station and a computation processing resource necessary for the baseband processing unit 230 of each base station. At that time, the scheduling unit 110 may use, for example, a linear programming method or a bin packing algorithm.

One example of a scheduling method based on the scheduling unit 110 has been described. However, the scheduling unit 110 may schedule a computation processing resource necessary for the baseband processing unit 230, by using another method.

(Method of Determining Selling Price of Vacant Computation Processing Resource)

One example of a method in which the resource selling unit 120 of the node control device 100 determines a selling price of a vacant computation processing resource is described.

The resource selling unit 120 may determine, for example, based on a previously provided standard unit price of a vacant computation processing resource, a selling price of a vacant computation processing resource. A standard unit price (per hour) of a vacant computation processing resource may be determined, for example, as follows.
A computation processing unit 210 including a CPU: one yen (for every one CPU core)
A computation processing unit 210 including an FPGA: two yen (for every 10% of a computation processing resource)
The memory unit 212: 0.2 yen (for every 1 GB)
The secondary storage unit 213: 0.05 yen (for every 1 GB)
The communication unit 214: 0 yen

The resource selling unit 120 presents, for example, through a web interface, at least one of a type, an amount, and a standard unit price of a vacant computation processing resource to the user device 400. The resource selling unit 120 may present, for example, a vacant computation processing resource for each certain time (e.g. one hour) and a selling price of the resource to the user device 400.

When the user device 400 purchases, for example, three hours' worth of a vacant computation processing resource of two CPU cores, 60% of a FPGA, 10 GB of a memory, and 20 GB of a secondary storage, the resource selling unit 120 determines, based on the following computation expression, a price of the vacant computation processing resource purchased by the user device 400.

(2×1+6×2+10×0.2+20×0.05)×3=51

A method of computing a selling price of a vacant computation processing resource described here is merely one example. The resource selling unit 120 may compute a selling price of a vacant computation processing resource, by using another method.

<Scheduling Computation Processing Resource>

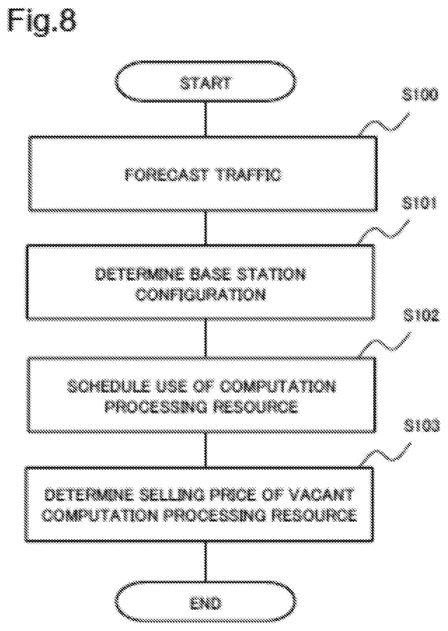

By using a flowchart illustrated in FIG. 8, a first operation example in which the node control device 100 schedules a computation processing resource of the communication node 200 is described. This processing may be started, for example, periodically (e.g. every day). The node control device 100 may schedule a computation processing resource until a certain period (e.g. one month) from a processing start time.

The node control device 100 may repeatedly execute scheduling, based on latest information (e.g. a traffic history).

As illustrated in FIG. 8, the traffic forecasting unit 140 computes, for example, by using the above-described method, a traffic forecast value for a processing target period (e.g. for one day after one month elapses from a processing start time) (step S100).

The base station configuration management unit 150 determines, based on the traffic forecast value acquired in step S100, a base station configuration of a processing target period (step S101). The base station configuration management unit 150 stores the determined base station configuration.

The scheduling unit 110 schedules, based on the base station configuration acquired in step S101, a usage schedule of a vacant computation processing resource of the communication node 200, for example, by using the above-described method (step S102).

The resource selling unit 120 excludes a computation processing resource used by the baseband processing unit 230 and an already-sold computation processing resource (i.e. an already-scheduled computation processing resource) from a total computation processing resource of the communication node 200. Thereby, the resource selling unit 120 can acquire a vacant computation processing resource. The resource selling unit 120 determines a selling price of the acquired vacant computation processing resource, for example, by using the above-described method (step S103). The resource selling unit 120 stores the determined selling price of the vacant computation processing resource.

<Selling Computation Processing Resource>

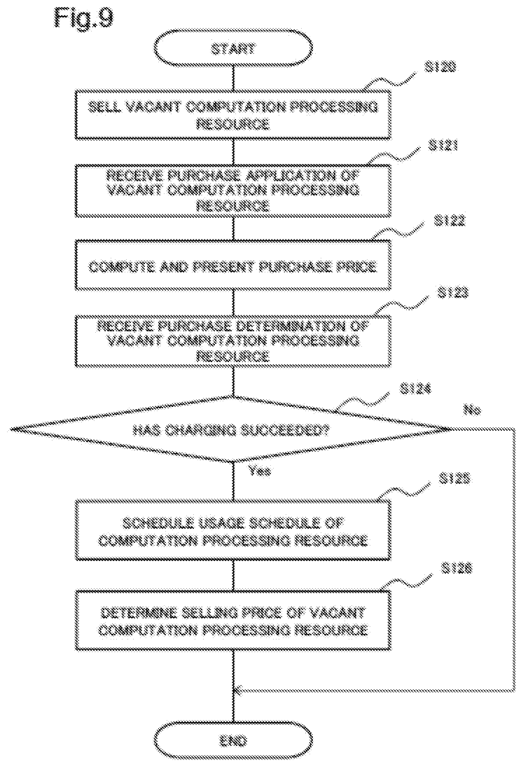

By using a flowchart in FIG. 9, a second operation example of the node control device 100 in which a vacant computation processing resource is sold to the user device 400 is described.

The resource selling unit 120 presents a vacant computation processing resource acquired in step S103 and a selling price of the resource to the user device 400 and sells the vacant computation processing resource to the user device 400 (step S120).

The resource selling unit 120 presents, to the user device 400, a web interface including, for example, a list of a computation processing resource and a selling price of the resource, and a purchase form. A purchase form includes, for example, information of a user, information of the user device 400, and a type, an amount, and a period of a resource to be purchased by a user, as well as a content of processing, information of data to be processed, and information for charging.

The resource selling unit 120 receives, from a user, an application for purchasing a vacant computation processing resource, for example, through a web interface (step S121).

An application for purchasing a vacant computation processing resource may include, for example, information of a user, information of the user device 400, and a type, an amount, and a period of a resource to be purchased by the user device 400, as well as a content of processing, information of data to be processed, and information for charging.

The resource selling unit 120 computes, from an order (a type, an amount, a period and the like of a computation processing resource to be purchased) acquired in step S121 and a selling price, a price of the purchased computation processing resource. The resource selling unit 120 presents the price to the user device 400, for example, through a web interface (step S122). A web interface may include, for example, a purchase determination button.

When a user presses a purchase determination button of the user device 400, the resource selling unit 120 receives a signal of the purchase determination (step S123).

The resource selling unit 120 charges, based on the information acquired in step S121 and the price determined in step S122, the user device 400 through a charging system (not illustrated) (step S124).

When charging fails in step S124, the resource selling unit 120 displays an error, for example, through a web interface. Thereafter, the present processing is terminated.

When charging succeeds in step S124, the resource selling unit 120 reports information of the sold computation processing resource to the scheduling unit 110. Specifically, the resource selling unit 120 reports, to the scheduling unit 110, information of a period in which a vacant computation processing resource is provided to the user device 400 and information of a type and an amount of the provided vacant computation processing resource.

The scheduling unit 110 having received the report reschedules a usage schedule of a computation processing resource possessed by the communication node 200 (step S125).

Specifically, the scheduling unit 110 selects, from a vacant computation processing resource of a specified period, a computation processing resource of a specified type and amount. Thereafter, the scheduling unit 110 appends a content of the selected computation processing resource to a resource distribution table.

The resource selling unit 120 determines, similarly to step S103, a selling price of a vacant computation processing resource, for example, by using the above-described method, with respect to a vacant computation processing resource acquired by excluding a computation processing resource used by the baseband processing unit 230 and a computation processing resource sold to the user device 400 from a total computation processing resource of the communication node 200 (step S126).

<Modification of Base Station Configuration>

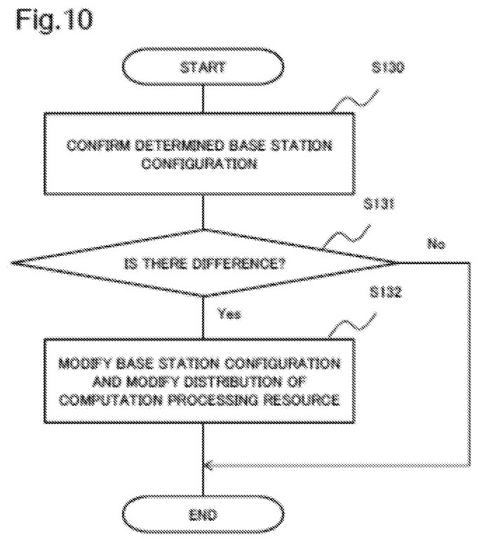

By using a flowchart in FIG. 10, a third operation example in which the node control device 100 modifies a base station configuration is described. Processing of modifying a base station configuration may be executed, for example, periodically (e.g. every minute).

The base station configuration management unit 150 confirms a base station configuration determined in step S101 (step S130).

The base station configuration management unit 150 confirms whether there is a difference between a current base station configuration and the base station configuration acquired in step S130 (step S131). When there is no difference (No in S131), the present processing is terminated.

In contrast, when there is a difference in step S131 (Yes in S131), the base station configuration management unit 150 and the scheduling unit 110 modify a base station configuration and modifies a computation processing resource used by the baseband processing unit 230 (step S132).

Specifically, when causing a base station having been invalid so far to be valid, the scheduling unit 110 instructs a computation processing control unit 220 of a communication node 200 having a computation processing resource having been scheduled for the base station to start an operation (i.e., baseband processing) of the baseband processing unit 230.

When causing a base station having been valid so far to be invalid, the scheduling unit 110 instructs the computation processing control unit 220 to stop an operation of the baseband processing unit 230.

The base station configuration management unit 150 may instruct the baseband processing unit 230 to modify a parameter of a base station.

The scheduling unit 110 instructs, when modifying a computation processing resource used by the baseband processing unit 230, the computation processing control unit 220 to modify a computation processing resource used for an operation of the baseband processing unit 230.

In addition, the scheduling unit 110 may execute control in accordance with a mobile communication standard such as modification of a base station of an accommodation destination of the user device 400 and the like, for example, in order to reduce an influence on quality of a communication service provided to the user device 400.

<User Information Processing>

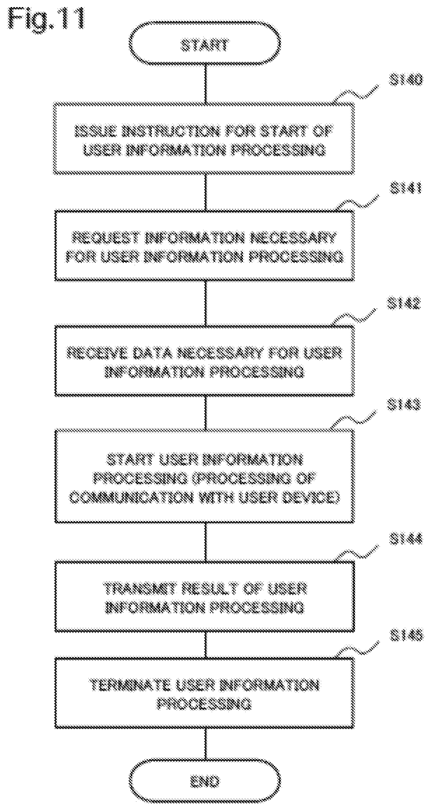

By using a flowchart in FIG. 11, the above-described user information processing is described as a fourth operation example. The processing is started, for example, at a start time specified from the user device 400 having purchased a vacant computation processing resource in step S121.

The scheduling unit 110 instructs the computation processing control unit 220 to start user information processing (step S140). In step S140, the scheduling unit 110 transmits, together with an instruction, scheduling information, information of a user, and information of the user device 400, as well as a content of processing and information of data to be processed to the computation processing control unit 220 of the communication node 200.

The computation processing control unit 220 requests processing information necessary for user information processing from the UE control unit 420 of the user device 400 (step S141).

Processing information necessary for user information processing is, for example, a virtual machine, an SW program, or a bitstream file relating to an FPGA being used or having been used by the UE user information processing unit 430.

The computation processing control unit 220 and the UE control unit 420 communicate, for example, by using the communication unit 214 and the UE communication unit 414.

The computation processing control unit 220 acquires data necessary for user information processing from the UE control unit 420 (step S142).

Data necessary for user information processing may be stored in the UE memory unit 412 or the UE secondary storage unit 413. Alternatively, data necessary for user information processing may be input from an input/output device, not illustrated, included in the user device 400.

The computation processing control unit 220 and the UE control unit 420 communicate, for example, by using the communication unit 214 and the UE communication unit 414.

The computation processing control unit 220 causes, based on the processing information and data received in step S141 and step S142, the user information processing unit 240 to start user information processing (step S143).

The user information processing unit 240 starts an operation of a virtual machine acquired in step S142, executes an SW program, or generates a bitstream file relating to an FPGA, for example, by using the computation processing unit 210 specified by scheduling information.

The user information processing unit 240 transmits, after terminating user information processing, a result of the user information processing to the UE control unit 420 (step S144).

The UE control unit 420 may cause, for example, the UE memory unit 412 or the UE secondary storage unit 413 to store the received result of the user information processing, the UE-UI unit 415 to display the result, and the UE user information processing unit 430 to take over the result.

The computation processing control unit 220 instructs the user information processing unit 240 to terminate user information processing and releases a computation processing resource having been used by the user information processing unit 240 (step S145).

When the user information processing unit 240 does not terminate user information processing within a time specified based on scheduling information, the computation processing control unit 220 may forcibly terminate an operation of the user information processing unit 240.

<Collection of Traffic Information>

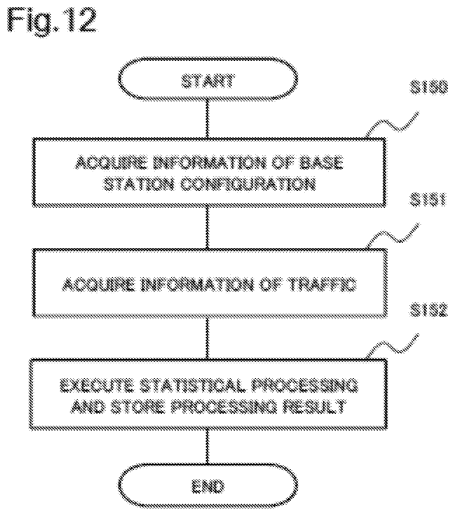

By using a flowchart in FIG. 12, a fifth operation example in which the node control device 100 collects traffic information is described. The processing is executed, for example, periodically (e.g. every minute).

The traffic history storage unit 130 acquires information relating to a base station configuration of a current time from the base station configuration management unit 150 (step S150).

The traffic history storage unit 130 acquires, with respect to each base station valid at a current time, traffic information from a baseband processing unit 230 associated with the base station (step S151).

The traffic history storage unit 130 executes statistical processing (averaging, distribution, aggregation, or the like), as necessary, for the traffic information acquired in step S151 and stores traffic information (see (A) of FIG. 5) in an internal database (step S152).

(Advantageous Effects of the First Example Embodiment)

As described above, the communication node 200 includes computation processing units 210-1 to n aggregated in order to process traffic. The communication node 200 forms, together with a plurality of wireless communication devices 300, a plurality of logical base stations.

The node control device 100 collects history information of traffic from each base station and forecasts traffic in a certain future time zone. The node control device 100 computes, based on a forecast result of traffic, a computation processing resource necessary for the baseband processing unit 230. The node control device 100 schedules a usage schedule of a computation processing resource. The node control device 100 determines a selling price of a remaining computation processing resource (vacant computation processing resource) and sells the vacant computation processing resource to the user device 400.

When the user device 400 purchases a vacant computation processing resource, the node control device 100 reschedules a computation processing resource. The node control device 100 and the communication node 200 cause, based on a rescheduling result, the baseband processing unit 230 and the user information processing unit 240 to operate.

Thereby, a computation processing resource aggregated in order to process traffic can be more efficiently used. An investment cost for a base station facility can be more rapidly recovered.

When a vacant computation processing resource is generated due to a decrease in traffic, it is possible to sell the vacant computation processing resource to the user device 400 and acquire a payment from the user device 400.

### MODIFIED EXAMPLES

According to the present example embodiment, an example in which the resource selling unit 120 computes, based on a standard unit price of a computation processing resource, a selling price of a vacant computation processing resource has been described. However, the present invention is not limited to this example.

According to one modified example, the resource selling unit 120 may set, by considering an amount of a vacant computation processing resource, a selling price of the vacant computation processing resource. When, for example, an amount of a vacant computation processing resource is larger than a standard value, the resource selling unit 120 may set, as a selling price of a computation processing resource, a unit price acquired by multiplying a standard unit price by a certain rate (less than 100%). In other words, the resource selling unit 120 discounts a price of a vacant computation processing resource.

According to another modified example, the resource selling unit 120 may set, by considering a position relation (a physical position and/or a position on a NW) between the user device 400 and a vacant computation processing resource, a selling price of a vacant computation processing resource.

The resource selling unit 120, for example, may reduce a selling price of a vacant computation processing resource of a communication node 200 at a relatively short distance from the user device 400 and in contrast, may raise a selling price of a vacant computation processing resource of a communication node 200 at a relatively far distance from the user device 400.

According to still another modified example, the resource selling unit 120 may set, by considering a sales history of a vacant computation processing resource, a selling price of a vacant computation processing resource. For example, the resource selling unit 120 may store, in a storage unit, a sales result (e.g. the number of sales, a standard unit price, and a unit selling price) of a vacant computation processing resource and refer to the sales result stored in the storage unit when setting a selling price of a vacant computation processing resource.

According to further another modified example, the resource selling unit 120 may present a selling price lower (or higher) than a standard unit price to a user device 400 having a large purchase volume of a vacant computation processing resource in the past. Alternatively, the resource selling unit 120 may present, to the user device 400, a selling price higher (or lower) than a standard unit price in an area or a time zone in which a sold-out rate of a vacant computation processing resource is high in the past.

According to still further another modified example, the scheduling unit 110 and/or the computation processing control unit 220 may schedule a computation processing resource in such a way as to reduce a mutual influence between an operation of the baseband processing unit 230 and an operation of the user information processing unit 240.

It is assumed that, for example, computation processing units 210-1 to 4 each are a CPU, the computation processing units 210-1 and 2 exist in a socket 0, and the computation processing units 210-3 and 4 exist in a socket 1. In this case, the scheduling unit 110 and the computation processing control unit 220 may preferentially distribute a computation processing resource of the computation processing units 210-1 and 2 to the baseband processing unit 230 and in contrast, may preferentially distribute a computation processing resource of the computation processing units 210-3 and 4 to the user information processing unit 240.

According to the present example embodiment, in scheduling of a computation processing resource illustrated in FIG. 8, after determination of a base station configuration (step S101), a computation processing resource was scheduled (step S102). However, the present invention is not limited thereto.

According to one modified example, steps S101 and S102 may be simultaneously executed. According to this configuration, the base station configuration management unit 150 and the scheduling unit 110 can determine a base station configuration by considering scheduling of a computation processing resource and can determine a base station configuration in such a way as to increase a vacant computation processing resource as much as possible.

Alternatively, the base station configuration management unit 150 may determine a base station configuration, by considering a sales situation of a vacant computation processing resource. The base station configuration management unit 150, for example, may preferentially cause a base station close to a user device 400 having purchased a vacant computation processing resource to be valid or may modify a parameter in such a way as to increase a communication speed or a communication capacity of the user device 400.

According to the present example embodiment, in scheduling of a computation processing resource illustrated in FIG. 8, the computation processing control unit 220 received processing information and data necessary for user information processing at a start time specified from a user device 400 having purchased a vacant computation processing resource in step S121 (steps S141 and S142). However, the present invention is not limited thereto.

According to one modified example, the computation processing control unit 220 may receive, before a specified start time, processing information and data necessary for user information processing from the UE control unit 420. In this case, the computation processing control unit 220 may instruct the baseband processing unit 230 to handle processing information necessary for user information and data communication as follows.
The communication is processed at low priority level.
The communication is processed on a best effort basis.
The communication is performed only when a communication band usage rate is equal to or less than a predetermined threshold.
The communication is performed only when a deviation between forecast traffic (i.e., a traffic forecast value) and actual traffic (i.e., a measured value) is large (when actual traffic is less).

The computation processing control unit 220 may execute communication control in cooperation with the UE control unit 420 in such a way as to be able to efficiently communicate with the user device 400. The computation processing control unit 220 may match a communication timing, for example, in synchronization with the UE control unit 420 or may execute flow control.

The core network 500 may execute charging for communication relating to processing information and data necessary for user information processing based on the UE communication unit 414, differently from another communication. The core network 500, for example, may set the communication based on the UE communication unit 414 to be free of charge or may discount a charge for the communication.

All or a part of processing information and data necessary for user information processing may be stored in the secondary storage unit 213 also after operation termination of the user information processing unit 240. According to this configuration, when the user device 400 purchases a computation processing resource and causes the user information processing unit 240 to operate, the core network 500 reads, instead of receiving processing information and data necessary for user information processing from the UE control unit 420, the same processing information and data from the secondary storage unit 213.

When processing information and data necessary for user information processing are changed or updated, the core network 500 may receive, from the UE control unit 420, only a part of processing information and data related to the change or update. According to this configuration, the resource selling unit 120, for example, may execute charging for use of the secondary storage unit 213 or may make an adjustment (make a discount or put a premium) on a selling price of a vacant computation processing resource when the user device 400 purchases a vacant computation processing resource next.

A communication node 200 that runs the user information processing unit 240 may be different from a communication node 200 that stores information and data necessary for user information processing. In this case, the processing information and data may be copied or moved between these two communication nodes 200.

According to the present example embodiment, the traffic forecasting unit 140 forecast traffic by using information stored in the traffic history storage unit 130 and a current time and/or information of a communication load. However, the present invention is not limited to this configuration.

According to one modified example, the traffic forecasting unit 140 may forecast traffic by considering, in addition to information stored in the traffic history storage unit 130 and a current time and/or a communication load, a computation processing resource already sold in a time zone to be forecast.

The traffic forecasting unit 140 may forecast traffic, for example, by considering a communication volume between the communication node 200 and the user device 400 generated in steps S141, S142, and S144.

Alternatively, the traffic forecasting unit 140 may weight a communication volume between the communication node 200 and the user device 400. The traffic forecasting unit 140, for example, may compute a communication volume for each unit time and further add a value acquired by multiplying the communication volume for each unit time by a predetermined value (e.g. 0.2) to a traffic forecast value. The reason is that a future communication volume between the communication node 200 and the user device 400 may be larger than a forecast value.

### Second Example Embodiment

According to the first example embodiment, a configuration in which the user device 400 and the communication node 200 wirelessly communicate by using a communication line provided based on a mobile communication service has been described.

According to a second example embodiment, a user device 400B and a communication node 200 communicate, by using a communication line or a path different from a communication line or a path provided based on a mobile communication service.

The second example embodiment of the present invention is described in detail with reference to drawings. In drawings referred to in description of the present example embodiment, the same component as and a step operating similarly to the first example embodiment of the present invention are assigned with the same reference sign, and detailed description according to the present example embodiment is omitted.

(Configuration of Computation Processing System 1B)

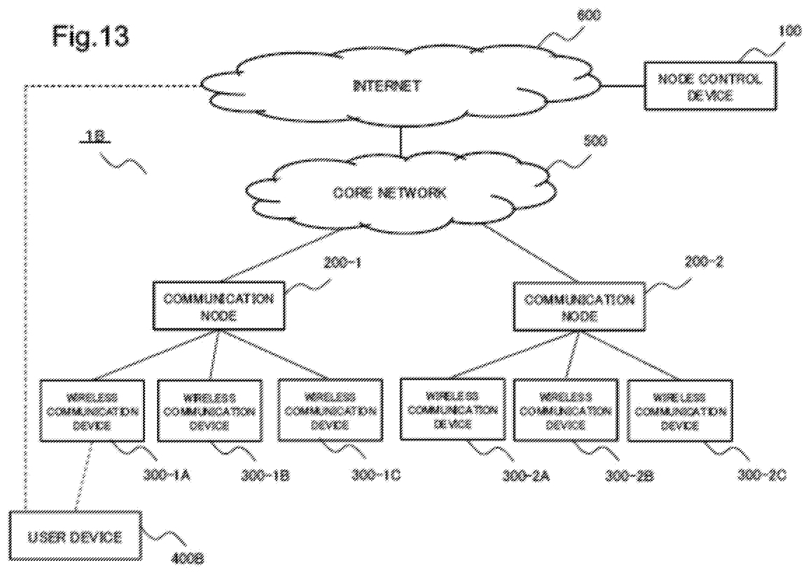

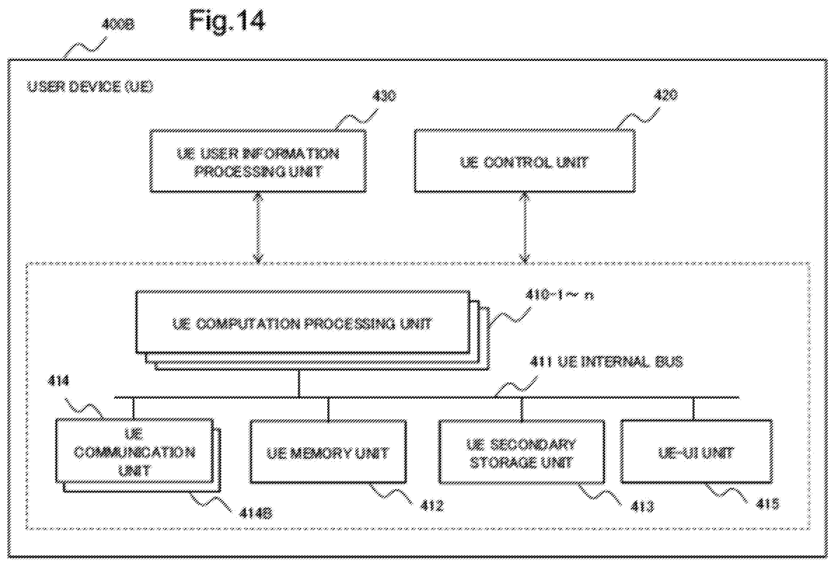

The second example embodiment is described by using FIGS. 13 and 14.

FIG. 13 is a diagram illustrating a configuration example of a computation processing system 1B according to the second example embodiment. The computation processing system 1B illustrated in FIG. 13 includes a node control device 100, communication nodes 200-1 and 2, wireless communication devices 300-1A to 2C, a user device 400B, a core network 500, and the Internet 600. However, the number of components and a connection relation illustrated in FIG. 13 are merely one example.

The user device 400B includes the same configuration and the same function as the user device 400 according to the first example embodiment. The user device 400B connects to the Internet 600, based on a method other than a mobile communication service provided by a mobile communication carrier operating the computation processing system 1B.

The user device 400B may connect to the Internet 600, for example, by using a wired or wireless communication service separate from a mobile communication service.

By using FIG. 14, a configuration example of the user device 400B according to the present example embodiment is described. The user device 400B illustrated in FIG. 14 includes UE computation processing units 410-1 to n, a UE internal bus 411, a UE memory unit 412, a UE secondary storage unit 413, a UE communication unit 414, a UE communication unit 414B, a UE-UI unit 415, a UE control unit 420, and a UE user information processing unit 430.

The UE communication unit 414B includes a function of a terminal of a communication service provided by a communication carrier and connects to the Internet 600.

According to the present example embodiment, a flow of processing in which the computation processing system 1B sells a vacant computation processing resource to the user device 400B is partially different from a flow of the same processing (see FIG. 9) according to the first example embodiment.

Specifically, according to the present example embodiment, in steps S120 and S121 of a selling flow of a vacant computation processing resource illustrated in FIG. 9, the resource selling unit 120 includes, in addition to a purchase application form received from the user device 400B, information relating to the UE communication unit 414B in information of the user device 400B.

According to the present example embodiment, in step S141 of the flow illustrated in FIG. 11, the computation processing control unit 220 receives processing information necessary for user information processing, by using the UE communication unit 414B and the Internet 600. In step S142, the computation processing control unit 220 receives data necessary for user information processing, by using the UE communication unit 414B and the Internet 600. In step S144, the user information processing unit 240 transmits a result of user information processing to the UE control unit 420, by using the UE communication unit 414B and the Internet 600.

(Advantageous Effect of the Second Example Embodiment)

As described above, according to the present example embodiment, the communication node 200 and the user device 400B communicate, by using a method other than a mobile communication service provided by a mobile communication carrier. Thereby, computation processing or communication processing can be accelerated and stabilized.

### MODIFIED EXAMPLES

According to the present example embodiment, an example in which the communication node 200 connects to the Internet 600 via the core network 500 has been described. However, the present invention is not limited to this example.

According to one modified example, it may be possible for the communication unit 214 to directly connect to the Internet 600. Alternatively, the communication node 200 may include a communication unit (e.g. the UE communication unit 414B in the user device 400B) different from the communication unit 214, and the communication unit may connect to the Internet 600.

According to one modified example, the user device 400B may include the UE communication unit 414B instead of the UE communication unit 414, and the node control device 100 and the communication node 200 may communicate, by using the UE communication unit 414B.

According to the present example embodiment, the user device 400B subscribes to a mobile communication service provided by a mobile communication carrier. However, the present invention is not limited thereto.

According to one modified example, the user device 400B may not necessarily subscribe to a communication service. The user device 400B may not necessarily be possessed or operated by a user. The user device 400B may be, for example, an information processing device borrowed by a user from a company providing a cloud service.

### Third Example Embodiment

According to the first example embodiment, an example in which after starting information processing, the user information processing unit 240 continues operating until a usage period of a computation processing resource is terminated has been described.

According to the present example embodiment, use of a computation processing resource based on the user information processing unit 240 is temporarily restricted according to a situation of traffic and the like.

A third example embodiment of the present invention is described in detail with reference to drawings. In drawings referred to in description of the present example embodiment, the same component as and a step operating similarly to the first example embodiment of the present invention are assigned with the same reference sign, and detailed description according to the present example embodiment is omitted.

(Configuration of Node Control Device 100C)

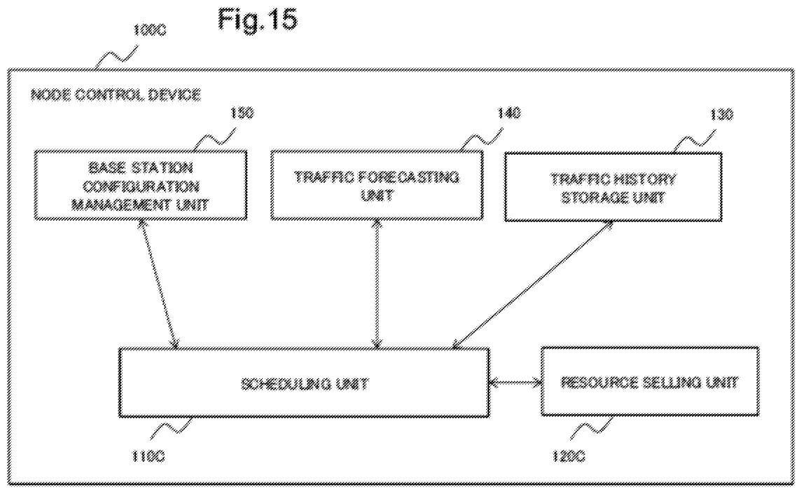

A configuration example according to the present example embodiment is described by using FIG. 15.

FIG. 15 is a block diagram illustrating a configuration of a node control device 100C according to the present example embodiment. Although not illustrated, a computation processing system according to the present example embodiment includes a configuration in which in the configuration of the computation processing system 1 according to the first example embodiment illustrated in FIG. 1, the node control device 100 according to the first example embodiment is replaced with the node control device 100C according to the present example embodiment.

By using FIG. 15, a configuration example of the node control device 100C according to the present example embodiment is described. As illustrated in FIG. 15, the node control device 100C includes a scheduling unit 110C, a resource selling unit 120C, a traffic history storage unit 130, a traffic forecasting unit 140, and a base station configuration management unit 150.

The scheduling unit 110C includes the same configuration and the same function as the scheduling unit 110 according to the first example embodiment. The scheduling unit 110C further reschedules use of a computation processing resource, by considering a difference between forecast traffic (i.e., a traffic forecast value) and a measured value of traffic.

The resource selling unit 120C updates a charge for a user device 400 having purchased a vacant computation processing resource, according to a result of rescheduling a usage schedule of a computation processing resource.

<F: Rescheduling>

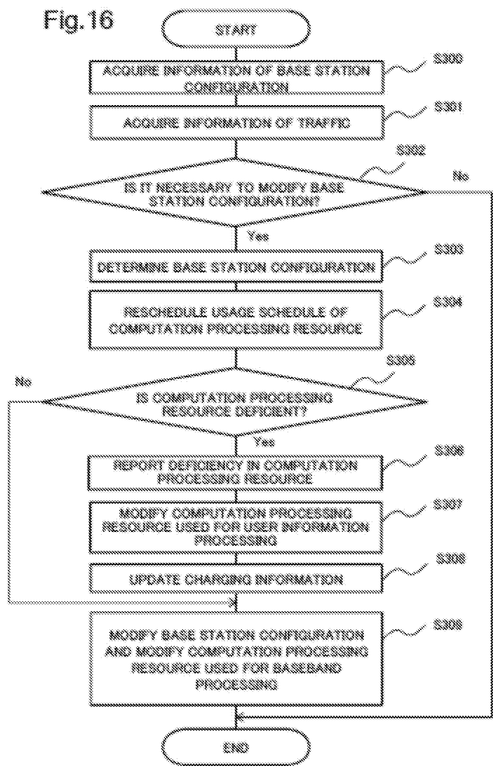

By using FIG. 16, a flow of processing in which a computation processing system 1C reschedules use of a computation processing resource of a communication node 200 is described. Rescheduling may be executed, for example, periodically (e.g. every minute).

The scheduling unit 110C acquires information relating to a current base station configuration from the base station configuration management unit 150 (step S300).

The scheduling unit 110C acquires information relating to traffic of a valid base station from a baseband processing unit 230 (step S301).

The scheduling unit 110C determines, based on the acquired information of the traffic of the base station, whether it is necessary to modify the current base station configuration (step S302).

The scheduling unit 110C, for example, divides a measured traffic value of a base station acquired in step S301 by a processing capability of the base station. When a result of the computation is equal to or more than a predetermine threshold, the scheduling unit 110C may determine to modify a base station configuration.

The base station configuration management unit 150 redetermines a base station configuration, based on current traffic acquired in step S301 (step S303). The base station configuration management unit 150 may redetermine a base station configuration in such a way that traffic acquired by multiplying a measured value of current traffic by a predetermined value can be processed.

The scheduling unit 110C determines, based on the base station configuration acquired in step S303, a usage schedule of a computation processing resource of the communication node 200 based on the baseband processing unit 230 (step S304). A method of determining, based on a base station configuration, a usage schedule of a computation processing resource has been described above, and therefore description of the method is omitted here.

The scheduling unit 110C compares a vacant computation processing resource in current scheduling with a computation processing resource necessary for a user information processing unit 240 during operation and thereby forecasts whether a computation processing resource is deficient (step S305).

When in step S305, it is forecast that a computation processing resource is deficient, the scheduling unit 110C reports modification of distribution of a computation processing resource to the user information processing unit 240 (step S306).

When receiving the report, the user information processing unit 240, for example, may cancel or suspend processing being executed, cause a UE user information processing unit 430 to take over the processing, or temporarily store a processing result.

In step S306, the scheduling unit 110C instructs a computation processing control unit 220 to modify a computation processing resource to be distributed to the user information processing unit 240. The scheduling unit 110C instructs the computation processing control unit 220 to reduce a computation processing resource to be distributed to the user information processing unit 240, for example, by a deficiency in a forecast computation processing resource.

The computation processing control unit 220 modifies, in accordance with the instruction from the scheduling unit 110C, a computation processing resource to be distributed to the user information processing unit 240 (step S307).

The scheduling unit 110C reports a fact that a computation processing resource to be distributed to the user information processing unit 240 has been modified to the resource selling unit 120C.

The resource selling unit 120C updates a charge for the user device 400 (step S308). For example, the resource selling unit 120C refunds, to the user device 400, a payment for a selling price corresponding to a computation processing resource unable to be used by the user information processing unit 240. Alternatively, the resource selling unit 120C may refund, to the user device 400, an amount of money equal to or more than a payment for a selling price of a computation processing resource. For example, an amount of money paid by the user device 400 as a payment for a vacant computation processing resource may be refunded to the user device 400. Alternatively, the resource selling unit 120C specially discounts a selling price of a vacant computation processing resource when the user device 400 purchases a vacant computation processing resource in the future.

The base station configuration management unit 150 and the scheduling unit 110C modify a base station configuration and modify a computation processing resource to be distributed to the baseband processing unit 230 (step S309). This processing is the same, for example, as the processing illustrated in step S132 of FIG. 10 described according to the first example embodiment.

(Advantageous Effect of the Third Example Embodiment)

As described above, according to the present example embodiment, the node control device 100C modifies a computation processing resource to be distributed to the user information processing unit 240 and modifies a base station configuration, according to a situation such as a change in traffic.

The node control device 100C reschedules use of a computation processing resource of the communication node 200. When, for example, traffic exceeds a forecast, the node control device 100C strengthens a processing capability of a base station. Thereby, a decrease in quality of a communication service can be avoided.

### MODIFIED EXAMPLE

According to the present example embodiment, a configuration in which when the scheduling unit 110C reduces a computation processing resource to be used for the user information processing unit 240, the resource selling unit 120C issues a refund to the user device 400 has been described. However, the present invention is not limited thereto.

According to one modified example, the scheduling unit 110C and the resource selling unit 120C may execute, for example, the following control.
The scheduling unit 110C and the resource selling unit 120C allows, also after a usage period of a computation processing resource based on the user information processing unit 240 is expired, the user information processing unit 240 to continue using a computation processing resource. In other words, a usage period of a computation processing resource based on the user information processing unit 240 can be extended.
The resource selling unit 120C sells, when there is a vacant computation processing resource, the vacant computation processing resource to the user device 400. In this case, how the resource selling unit 120C executes charging to the user device 400 is not specifically limited. The resource selling unit 120C, for example, may discount a payment for a computation processing resource additionally sold to the user device 400.
The scheduling unit 110C additionally distributes, when a vacant computation processing resource is generated, the vacant computation processing resource to the user information processing unit 240.
The scheduling unit 110C searches for a communication node 200 having a vacant computation processing resource. The scheduling unit 110C schedules, when being able to find such a communication node 200, a computation processing resource for the user information processing unit 240 in the communication node 200. The scheduling unit 110C causes the user information processing unit 240 to operate on the communication node 200. At that time, for example, virtual machine migration/live migration is usable.

According to the present example embodiment, when a result acquired by dividing a measured value of traffic by a traffic processing capability of a current base station configuration is equal to or more than a predetermined threshold, the scheduling unit 110C determines to modify a base station configuration. However, the present invention is not limited thereto.

According to one modified example, the scheduling unit 110C may determine to modify a base station configuration when a measured value of traffic processed by a certain base station included in a current base station configuration exceeds a predetermined threshold.

Alternatively, the scheduling unit 110C may acquire, from the computation processing control unit 220, a usage rate (e.g. a CPU usage rate) of a computation processing resource distributed to a baseband processing unit 230 associated with a base station and determine to modify a base station configuration when the usage rate is equal to or more than a predetermined threshold.

### Fourth Example Embodiment

According to the present example embodiment, a minimum configuration of a node control device according to one aspect of the present invention is described.

(Configuration of Node Control Device 100D)

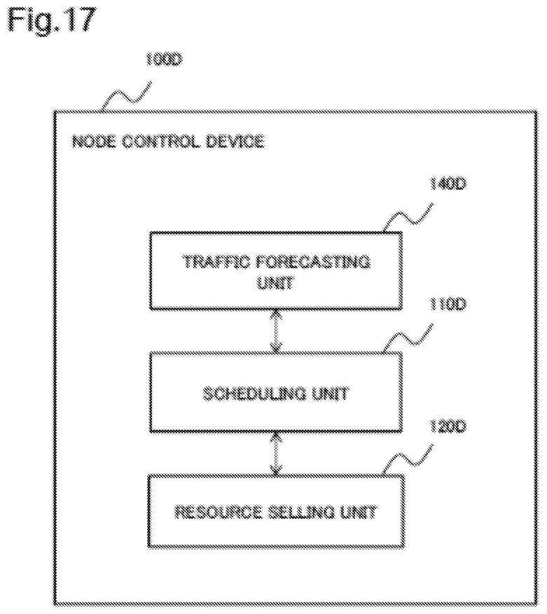

FIG. 17 is a block diagram illustrating a configuration of a node control device 100D according to the present example embodiment. As illustrated in FIG. 17, the node control device 100D includes a traffic forecasting unit 140D, a scheduling unit 110D, and a resource selling unit 120D.

The traffic forecasting unit 140D forecasts traffic passing through a communication node (not illustrated).

The scheduling unit 110D determines, in order to process a forecast traffic, a usage schedule of a computation processing resource possessed by a communication node.

The resource selling unit 120D supplies, when a communication node possesses a vacant computation processing resource that is not scheduled to be used, the vacant computation processing resource.

(Advantageous Effect of the Present Example Embodiment)

According to a configuration of the present example embodiment, when a communication node possesses a computation processing resource that is not scheduled to be used (e.g. based on baseband processing and the like), the vacant computation processing resource is supplied. Therefore, a computation processing resource of a communication node can be more efficiently used. A supply destination of a vacant computation processing resource may be, for example, a user device (not illustrated) using a mobile communication network.

### Fifth Example Embodiment

A node control device 100E according to the present example embodiment is achieved as a computer device including a central processing unit (CPU) and a memory. Alternatively, a control function of the node control device 100E may be achieved as a hardware device by using an electronic circuit and a machine.

(Configuration of Node Control Device 100E)

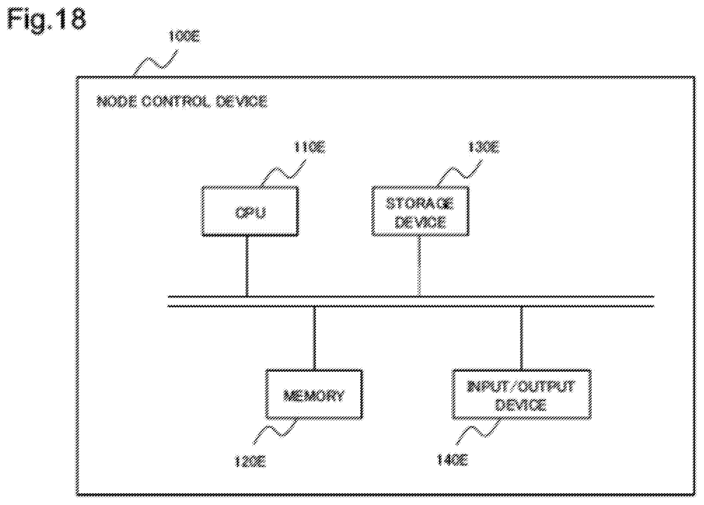

FIG. 18 illustrates one example of a hardware configuration of the node control device 100E. As illustrated in FIG. 18, the node control device 100E includes a CPU 110E, a memory 120E, a storage unit 130E, and an input/output device 140E.

The CPU 110E executes, for example, functions of the scheduling unit 110 (110C), the resource selling unit 120 (120C), the traffic forecasting unit 140, and the base station configuration management unit 150 of the node control device 100 (100C) according to the first example embodiments 1 to 3.

Alternatively, the CPU 110E can achieve functions of the traffic forecasting unit 140D, the scheduling unit 110D, and the resource selling unit 120D of the node control device 100D according to the fourth example embodiment.

The storage device 130E includes, for example, the traffic history storage unit 130 of the node control device 100 (100C) according to the first to third example embodiments.

In the node control device 100E, the CPU 110E reads a program stored on a non-volatile memory. The CPU 110E writes the program read from the non-volatile memory to the memory 120E and executes an instruction. Thereby, the CPU 110E achieves a control function of the node control device 100E. The CPU 110E outputs, from the input/output device 140E, a result of executing an instruction (here, a baseband signal, a result of information processing specified by a user device 400).

(Advantageous Effect of the Present Example Embodiment)

According to the configuration of the present example embodiment 4, the configuration of the node control device 100 (100C, 100E) described according to the first to fourth example embodiments is achieved by a computer device or a hardware device. Thereby, a computation processing resource can be more efficiently used, as described according to the first example embodiment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-203660, filed on Oct. 20, 2017, the disclosure of which is incorporated herein in its entirety by reference.

### REFERENCE SIGNS LIST

1, 1B Computation processing system

100 Node control device

100C Node control device

100D Node control device

100E Node control device

200 Communication node

300 Wireless communication device

400, 400B User device

110, 110C, 110D Scheduling unit

120, 120C, 120D Resource selling unit

140, 140D Traffic forecasting unit

150 Base station configuration management unit

What is claimed is:

1. A node control device comprising one or more memories storing instructions and one or more processors configured to execute the instructions to:
forecast traffic passing through a communication node;
determine a usage schedule of a computation processing resource on the communication node in order to process the forecast traffic; and
sell a remaining vacant computation processing resource acquired by excluding a computation processing resource determined to be used from a total computation processing resource possessed by the communication node.

2. The node control device according to claim 1, wherein
the one or more processors configured to execute the instructions to determine, when the vacant computation processing resource is purchased from a user device, a usage schedule of the computation processing resource based on an instruction from the user device.

3. The node control device according claim 1, wherein
the one or more processors configured to execute the instructions to modify a usage schedule of the computation processing resource according to a load situation of the communication node.

4. The node control device according to claim 1, wherein
the communication node constitutes a base station, together with one or more wireless communication devices that wirelessly communicate with a user device, and
the one or more processors configured to execute the instructions to determine validation or invalidation of each wireless communication device constituting the base station.

5. The node control device according to claim 4, wherein
the one or more processors configured to execute the instructions to determine at least one of an amount and a type of a computation processing resource to be used of the communication node, and a usage time of the computation processing resource.

6. The node control device according to claim 4, wherein
the one or more processors configured to execute the instructions to modify a configuration of the base station according to a load situation of the communication node.

7. The node control device according to claim 1, wherein
the communication node executes baseband processing by using the computation processing resource.

8. A computation processing system comprising:
the node control device according to claim 1;
the communication node controlled by the node control device; and
one or more wireless communication devices that connect to the communication node and wirelessly communicate with a user device.

9. A node control method comprising:
forecasting traffic passing through a communication node;
determining a usage schedule of a computation processing resource on the communication node in order to process the forecast traffic; and
selling a remaining vacant computation processing resource acquired by excluding a computation processing resource determined to be used from a total computation processing resource possessed by the communication node.

10. A non-transitory recording medium storing a program that causes a computer to execute:
forecasting traffic passing through a communication node;
determining a usage schedule of a computation processing resource on the communication node in order to process the forecast traffic; and
selling a remaining vacant computation processing resource acquired by excluding a computation processing resource determined to be used from a total computation processing resource possessed by the communication node.
